(19) United States
(12) Patent Application Publication
(10) Pub. No.: US 2024/0177319 A1
(43) Pub. Date: May 30, 2024

(54) IMAGE ANALYSIS METHOD AND IMAGE ANALYSIS SYSTEM

(71) Applicant: MEDIATEK INC., Hsin-Chu (TW)

(72) Inventors: Ting-Hsuan Liao, Hsinchu City (TW); Huang-Ru Liao, Hsinchu City (TW); Shan-Ya Yang, Hsinchu City (TW); Jie-En Yao, Hsinchu City (TW); Li-Yuan Tsao, Hsinchu City (TW); Hsu-Shen Liu, Hsinchu City (TW); Bo-Wun Cheng, Hsinchu City (TW); Chen-Hao Chao, Hsinchu City (TW); Chia-Che Chang, Hsinchu City (TW); Yi-Chen Lo, Hsinchu City (TW); Chun-Yi Lee, Hsinchu City (TW)

(73) Assignee: MEDIATEK INC., Hsin-Chu (TW)

(21) Appl. No.: 18/518,609

(22) Filed: Nov. 24, 2023

Related U.S. Application Data
(60) Provisional application No. 63/384,972, filed on Nov. 25, 2022.

(51) Int. Cl. G06T 7/12; G06T 7/13; G06T 9/00

(52) U.S. Cl. CPC G06T 7/12; G06T 7/13; G06T 9/00

(57) ABSTRACT

Many unsupervised domain adaptation (UDA) methods have been proposed to bridge the domain gap by utilizing domain invariant information. Most approaches have chosen depth as such information and achieved remarkable successes. Despite their effectiveness, using depth as domain invariant information in UDA tasks may lead to multiple issues, such as excessively high extraction costs and difficulties in achieving a reliable prediction quality. As a result, we introduce Edge Learning based Domain Adaptation (ELDA), a framework which incorporates edge information into its training process to serve as a type of domain invariant information. Our experiments quantitatively and qualitatively demonstrate that the incorporation of edge information is indeed beneficial and effective, and enables ELDA to outperform the contemporary state-of-the-art methods on two commonly adopted benchmarks for semantic segmentation based UDA tasks. In addition, we show that ELDA is able to better separate the feature distributions of different classes.

### CROSS REFERENCE TO RELATED APPLICATIONS

This application claims the benefit of U.S. Provisional Application No. 63/384,972, filed on Nov. 25, 2022. The content of the application is incorporated herein by reference.

### BACKGROUND

A number of unsupervised domain adaptation (UDA) methods have been proposed in an attempt to bridge the discrepancies between different domains. One category of these works adopted adversarial training process to learn representations of their target domains. These frameworks often consist of a generator and a discriminator trained against each other in order to minimize the domain gap, and have shown significant improvements over those trained in the source domains only without the use of any adaptation technique. Another line of work has focused on self-training and data augmentation measures to tackle UDA problems. For those utilizing self-training, the concentration was mainly on preventing over-fitting by using regularization or class-balancing when minimizing uncertainty in their target domains. The authors in extended the concept of self-training and proposed a data augmentation technique. It fine-tunes a model with mixed labels generated by combining ground truth annotations from a source domain and pseudo labels from a target domain. Recent researchers further employed ensemble learning to deal with the above challenge.

A few recent researchers have turned their attention to incorporating domain invariant features into the training processes of their UDA methods. To achieve this objective, a commonly adopted method is to introduce them through auxiliary tasks. Among these tasks, depth estimation is the most widely used one. The main incentive behind this is that geometric and semantic information are highly correlated. This concept uses synthetic semantic segmentation and depth information as additional means of regularization for their style transfer model. One conventional method is proposed to shrink the domain gap by fusing segmentation and depth maps together during the adversarial training process. Moreover, another conventional method explicitly exploits a segmentation path and a depth estimation path in their UDA framework, where the latter path serves as an auxiliary task. These two paths are interleaved, in which the embedding from them are fused together using attention layers such that two paths can mutually benefit from each other. In addition, the prediction discrepancies are leveraged from two depth decoders to assist in pseudo-label refinement for the segmentation path. Furthermore, more auxiliary paths, including depth estimation, surface normal, as well as self-supervised photometric loss, are leveraged in their UDA model. However, the aforementioned methods require additional depth estimation models trained based on certain self-supervised learning approaches.

Edge detection has been utilized in a wide variety of computer vision research domains such as semantic segmentation, object detection, facial recognition, and representation learning. Edges are low-level representations extracted from images that are able to reflect important information about the discontinuities in depth, surface orientation, material properties, as well as scene illumination in images. Besides its abundance in semantic information, edges from an image can be easily extracted using conventional computer vision approaches such as Sobel and Canny edge extraction algorithms. These algorithms are efficient and straightforward and do not require the use of any learnable parameter. Therefore they are considered readily available from almost all image domains, and meet the characteristics of domain invariant features. Despite these advantages, the use of edge information has not been explored in semantic segmentation based UDA tasks.

### SUMMARY

The present invention provides an image analysis method applied to edge learning and semantic segmentation based domain adaptation and a related image analysis system for solving above drawbacks.

According to the claimed invention, an image analysis method applied to edge learning and semantic segmentation based domain adaptation includes acquiring at least one input image, analyzing the input image to generate an edge feature of the input image, and utilizing the edge feature to generate a final semantic segmentation loss relevant to the input image.

According to the claimed invention, an image analysis system includes an operation processor adapted to acquire at least one input image, analyze the input image to generate an edge feature of the input image, and utilize the edge feature to generate a final semantic segmentation loss relevant to the input image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an input image, an edge map and a depth map according to an embodiment of the present invention.

FIG. 2 is a functional block diagram of an image analysis system according to the embodiment of the present invention.

FIG. 3 is a diagram of illustrating an overview of the proposed Edge Learning based Domain Adaptation framework according to the embodiment of the present invention.

FIG. 4 is a flow chart of an image analysis method according to the embodiment of the present invention.

### DETAILED DESCRIPTION

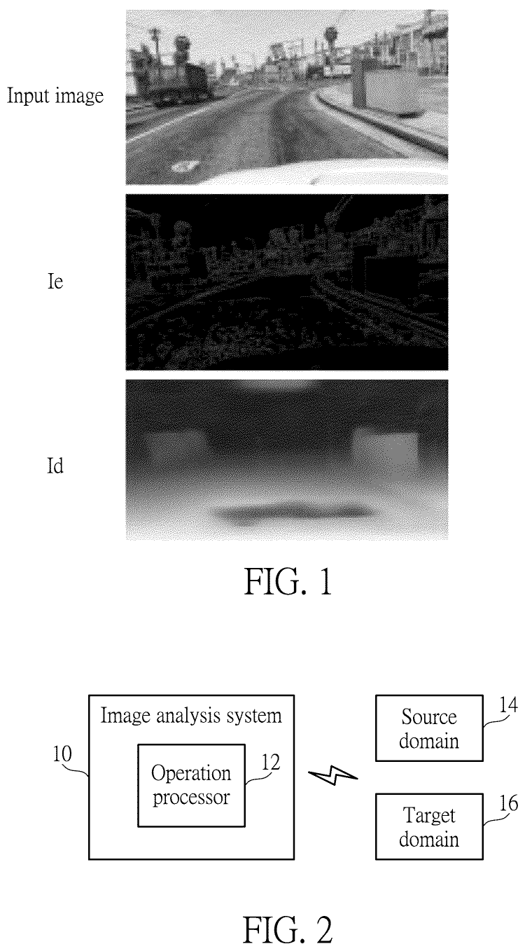

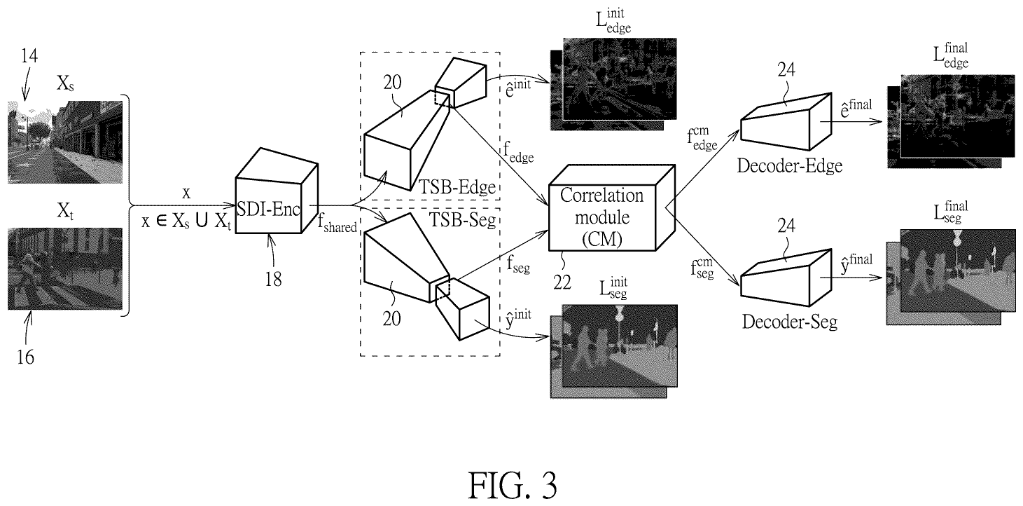

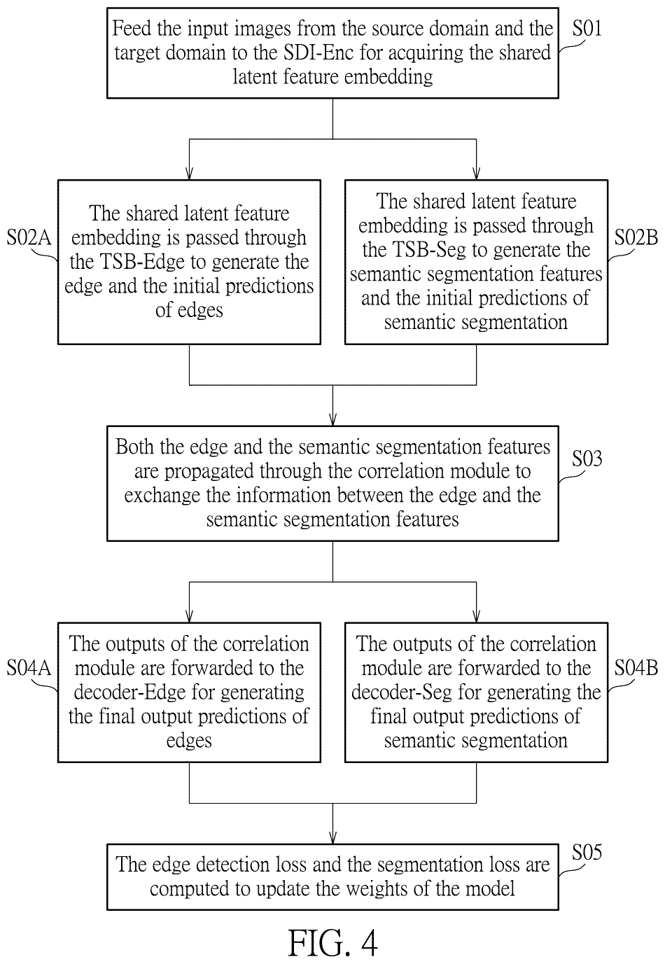

Please refer to FIG. 1 to FIG. 4. FIG. 1 is a diagram of an input image, an edge map Ie and a depth map Id according to an embodiment of the present invention. FIG. 2 is a functional block diagram of an image analysis system 10 according to the embodiment of the present invention. FIG. 3 is a diagram of illustrating an overview of the proposed Edge Learning based Domain Adaptation (ELDA) framework according to the embodiment of the present invention. FIG. 4 is a flow chart of an image analysis method according to the embodiment of the present invention. Supervised learning for semantic segmentation has achieved unprecedented successes in the past few years. Albeit effective, training a semantic segmentation model in a supervised manner requires pixel-level labeling, which is often prohibitively expensive and time-consuming. Being aware of these undesirable drawbacks, recent studies have been attempting to make use of the existing labeled datasets or simulated environments to train semantic segmentation models, and then adapt the models to certain label-less targeted domains. This category of research direction is often referred to as semantic segmentation based the unsupervised domain adaptation (UDA) in the computer vision community. A number of approaches have been explored to tackle this challenge, including adversarial training, anchoring, and pseudo labeling (PL), and have achieved remarkable adaptation performance. However, they rely solely on the semantic labels in the source domain 14 and the raw input data in the target domain 16, which limits their performance and thus leaves room for further improvements.

In light of these shortcomings, another branch of work has incorporated domain invariant information into their training processes to help bridge the domain gaps confronted by them. Domain invariant information possess a favorable property: the concept it represents is general across different domains. This property makes it highly desirable for UDA tasks as it is robust against domain gaps. As a result, such property has inspired researchers to explore the usage of domain invariant information in their UDA methods, in which it is oftentimes embedded into the training objectives of some auxiliary tasks. A commonly adopted type of domain invariant information is depth, which contains clues relating to the distance of the surfaces of scene objects from a viewpoint. A number of methods have been proposed to leverage depth information to help shrink the domain gap. Self-supervised learning (SSL) is further utilized to retrieve depth information, with an aim of assisting semantic segmentation based UDA tasks, and achieved remarkable performance.

Unfortunately, the methods that utilized SSL to retrieve depth information have two crucial constraints: First, the computational cost associated with training an accurate auxiliary SSL-based depth estimation model is often expensive. A few researchers even employed two separate depth estimation models in both the source domain 14 and the target domain 16 to ensure the quality of the generated depth estimation. This worsens the computational burden incurred, and makes such methods less suitable for real world applications. Second, since SSL-based models have no access to ground truth labels, their performance are not comparable to physical sensors (e.g., lidar, stereo camera, etc.) or supervised models in terms of accuracy. In other words, their predictions might deviate from the ground truths, and hence might bring negative impacts on the training process of the semantic segmentation based UDA methods.

Being aware of the problems associated with using SSL based depth estimation to assist in the training processes of UDA model, we propose to replace it with edges, which is also a type of domain invariant information. The benefits are twofold. First, the computational cost of extracting edges from an input image is substantially lower than those of extracting a depth map from the same image using SSL. Specifically, edges in an image can be obtained by performing convolution using certain fixed kernels over the input image in one pass, while the extraction of a depth map usually requires training and inferencing of a sophisticated depth model. Second, the quality of edges is typically much more consistent than that of depth maps, as depth estimation using only RGB images is an ill-posed problem, and is susceptible to the influences of noises, model architectures, and data distributions. On the contrary, edges are relatively consistent, and less likely to deviate from the ground truth. FIG. 1 depicts a motivational example of such characteristics, in which the object boundaries are better captured in the extracted edge map Ie. In contrast, the depth map Id is noisy and the object boundaries are relatively blurred. The availability of such high quality boundary information thus offers a promising way to enable a model to better adapt to the target domain 16. An example that depicts the differences between the edge map Ic and the depth map Id extracted by the input image without the use of any ground truth labels. For the depth map Id, nearer surfaces are brighter, while farther ones are darker.

In order to validate the aforementioned motivation, and take full advantage of the high quality edge information, we propose Edge Learning based Domain Adaptation, abbreviated as ELDA. ELDA utilizes edges as the domain invariant information by incorporating edge extraction into its training process as an auxiliary task. The experimental results show that without resorting to ensemble distillation methods or transformer based architectures, ELDA is able to achieve the state-of-the-art performance on two commonly adopted benchmarks. The contributions of this work are summarized as follows: the use of edge information is introduced as an auxiliary task for semantic segmentation based UDA, and develop an effective framework named ELDA, to take full advantage of the valuable edge information embedded in the images of both domains; ELDA is validated on two commonly adopted benchmarks quantitatively and qualitatively, and show that it is able to achieve superior performance to the previous methods; the present invention demonstrates that by incorporating edge information into semantic segmentation based UDA, ELDA can capture fine-grained features in the unlabeled target domain 16.

In UDA tasks, a model has access to a source dataset Xₛ={xₛ¹, . . . ,xₛ^{N}}, their corresponding labels Yₛ={yₛ¹, . . . , yₛ^{N}}, and a target dataset Xₜ={xₜ¹, . . . , xₜ^{M}}, where N and M denote the number of instances from the source domain 14 and target domain 16, respectively. Specifically, a tuple (xₛ, yₛ) represents an image-label pair from the source domain 14, and xₜ represents a target domain image. The training objective is to train a model such that its predictions can best estimate the ground truth labels in the target domain 16. In other words, the mean intersectionover-union (mIoU) of the predictions from the model should be maximized. For the detailed notation used in our work, please refer to the notation table in the supplementary material.

The image analysis system 10 includes an operation processor 12 adapted to executing the proposed ELDA framework of the present invention. The operation processor 12 can acquire the input image from the source domain 14 and/or the target domain 16, and execute the image analysis method of the present invention. FIG. 3 illustrates an overview of the proposed ELDA framework. First, the input image from either the source domain 14 (i.e., xₛϵXₛ) or the target domain 16 (i.e., xₜϵXₜ) is first fed into a shared domain invariant encoder (SDI-Enc 18) to obtain the shared latent feature embedding (f_{shared}). Subsequently, f_{shared} is passed through two separate task specific branches (TSBs 20), to generate the task specific features, i.e., the edge (f_{edge}) and the semantic segmentation (f_{seg}) features, and the initial predictions of edges (êₛ^{init} or êₜ^{init}) as well as semantic segmentation (y\hat{ }ₛ^{init} or y\hat{ }ₜ^{init}). Both f_{edge} and f_{seg} are then propagated through a correlation module (CM 22) to exchange information between f_{edge} and f_{seg}. Then, the outputs of CM 22 are forwarded to two distinct decoders 24 to generate the final output predictions of edges (êₛ^{final} or êₜ^{final}) and semantic segmentation (ŷₛ^{final} or ŷₜ^{final}), respectively, where subscripts s and t denote the source domain 14 and the target domain 16. The edge detection loss L_{edge} and the segmentation loss L_{seg} are computed to update the model's weights. In the following subsections, we explain the components of ELDA. In the following Sections, the present invention elaborates on the details of SDI-Enc 18, TSBs 20, and CM 22, the present invention further describes the formulations of the loss functions L_{edge} and L_{seg}.

In auxiliary task learning, shared encoders are usually adopted to extract common features so as to enhance performance and reduce inference cost. ELDA employs the shared encoder structure to extract f_{shared} for capturing both edge and segmentation features.

To enable f_{shared} to be further interpreted into specific feature embedding that bear edge and semantic segmentation meanings, two separate branches of TSBs 20 (such as the TSB-Edge 20 and the TSB-Seg 20) are utilized to generate initial edge and segmentation predictions. The two TSBs 20 contain their separate encoders and decoders 24. The encoders are in charge of encrypting f_{shared} into task specific features f_{edge} and f_{seg}, which are later fed to the CM 22. Meanwhile, the decoders 24 are employed to decode f_{edge} and f_{seg} in to êₛ^{init} or êₜ^{init} and ŷₛ^{init} or ŷₜ^{init}, respectively, depending on the original domain of the input image, for updating SDI-Enc 18 and the TSBs 20. Please note that ê represents the edge predictions, ŷ denotes the semantic segmentation predictions, and the subscripts s and t stand for the source domain 14 and the target domain 16.

With an aim to communicate information between f_{edge} and f_{seg}, we employ a CM 22 into ELDA. Specifically, within CM 22, the information in f_{edge} and f_{seg} are first filtered with sigmoid functions to re-weight the task specific intermediate embedding features f_{mid}^{seg} and f_{mid}^{edge} as:

f_{seg}^{mid}=Conv(f_{seg}), f_{edge}^{mid}=Conf(f_{edge}) Formula 1

f_{seg}^{cm}=f_{seg}+f_{edge}^{mid}*Sigmoid(Conv(f_{edge})) Formula 2

f_{edge}^{cm}=f_{edge}+f_{seg}^{mid}*Sigmoid(Conv(f_{seg})) Formula 3
where Conv(⋅) and Sigmoid(⋅) denote the convolution and sigmoid functions, and f_{cm}^{seg} and f_{cm}^{edge} are the outputs of CM 22. CM 22 assists in preserving the essential features from both the TSBs 20.

In ELDA, the supervision targets for edges in both the source domain 14 and the target domain 16 are generated using the Canny edge extraction algorithm denoted as C(⋅; σ), where σ is the parameter for controlling the smoothness of an edge map. The edge loss L_{edge}=L^{init}_{edge}+L^{final}_{edge} is then computed between the edge predictions from ELDA and the edges generated by C(⋅; σ). Both L^{init}_{edge} and L^{final}_{edge} are derived by extending the DICE loss, as it is able to prevent imbalance between different classes. The expressions of L^{init}_{edge} and L^{final}_{edge} are formulated as:

$${L}_{edge}^{i n i t} = ( 1 - D ( C ( {x}_{s} ; σ ) , {\hat{e}}_{s}^{i n i t} ) ) + ( 1 - D ( C ( {x}_{t} ; σ ) , {\hat{e}}_{t}^{i n i t} ) ) \qquad Formula 4$$

$${L}_{edge}^{final} = ( 1 - D ( C ( {x}_{s} ; σ ) , {\hat{e}}_{s}^{final} ) ) + ( 1 - D ( C ( {x}_{t} ; σ ) , {\hat{e}}_{t}^{final} ) ) \qquad Formula 5$$

$$D ( e , \hat{e} ) = \frac{2 {\sum }_{i = 1}^{P} e \hat{e}}{{\sum }_{i = 1}^{P} {e}^{2} + {\sum }_{i = 1}^{P} {\hat{e}}^{2}} , 0 \leq D \leq 1 \qquad Formula 6$$

where P represents the number of pixels in the input image, D(⋅) denotes the DICE loss operator, eϵ{0, 1} represents the edges generated by C(⋅; σ), and êϵ{0, 1} denotes the edges predicted by ELDA. Please note that ê can be any of êₛ^{init}, êₜ^{init}, êₛ^{final}, êₜ^{final}.

In ELDA, the training targets for semantic segmentation in the source domain 14 are the ground truth labels, while those in the target domain 16 are the pseudo labels generated using ELDA's predictions. The loss for semantic segmentation L_{seg}=L^{init}_{seg}+L^{final}_{seg} is then computed between the predictions of ELDA and the training targets by utilizing the cross-entropy (CE) operator CE(⋅). The expressions of the loss components L^{init}_{seg} and L^{final}_{seg} are formulated as follows:

L_{seg}^{final}=CE(yₛ,y\hat{ }ₜ^{final})+CE(y′ₜ, y\hat{ }ₜ^{final}) Formula 7

L_{seg}^{init}=CE(yₛ,y\hat{ }ₜ^{init})+CE(y′ₜ, y\hat{ }ₜ^{init}) Formula 8
where CE(y, ŷ)=−Σᵢ₌₁^{P}ylog ŷ, yₜ′ represents the pseudo-labels in the target domain 16, and y denotes the segmentation labels, which can be either yₛ or yₜ′. Finally, ŷ denotes the predicted segmentation maps. Please note that \hat{ }y can be any of ŷₛ^{init}, ŷₜ^{init}, ŷₛ^{final}, ŷₜ^{final}.

Based on the above derivations, the total loss can be formulated as Lₜₒₜₐₗ=L_{seg}+λL_{edge}, where λ is a balancing factor whose value is provided in the supplementary material.

As shown in FIG. 4, step S01 can be executed to feed the input images from the source domain 14 and the target domain 16 to the SDI-Enc 18 for acquiring the shared latent feature embedding fₛₕₐᵣₑ. Then, step S02A and step S02B can be executed that the shared latent feature embedding fₛₕₐᵣₑ can be used to generate the task specific task, such as the edge f_{edge} and the initial predictions of edges êₛ^{init} or êₜ^{init}, through the TSB-Edge 20 and the TSB-Seg 20, and the shared latent feature embedding fₛₕₐᵣₑ can be used to further generate the semantic segmentation features f_{seg} and the initial predictions of semantic segmentation y\hat{ }ₛ^{init} or y\hat{ }ₜ^{init}.

After that, step S03 can be executed that both the edge f_{edge} and the semantic segmentation features f_{seg} are propagated through the correlation module 22 to exchange the information between the edge f_{edge} and the semantic segmentation features f_{seg}. Then, step S04A and step S04B can be executed that the outputs of the correlation module 22 are forwarded to the Decoder-Edge 24 and the Decoder-Seg 24 for generating the final output predictions of edges êₛ^{final} or êₜ^{final} and the final output predictions of semantic segmentation ŷₛ^{final} or ŷₜ^{final}. Final, step S05 can be executed to update the weights of the model via the computation of the edge detection loss L_{edge} and the segmentation loss L_{seg}. Therefore, the image analysis method illustrated in FIG. 4 can be applied for the image analysis system 10 shown in FIG. 2 and the proposed ELDA framework shown in FIG. 3, so that the present invention can quantitatively and qualitatively demonstrate that the incorporation of edge information is indeed beneficial and effective, and enables the proposed ELDA to outperform the contemporary state-of-the-art methods on two commonly adopted benchmarks for semantic segmentation based UDA tasks, and can further show that ELDA is able to better separate the feature distributions of different classes for the preferred design decisions.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image analysis method applied to edge learning and semantic segmentation based domain adaptation, the image analysis method comprising:
acquiring at least one input image;
analyzing the input image to generate an edge feature of the input image; and
utilizing the edge feature to generate a final semantic segmentation loss relevant to the input image.

2. The image analysis method of claim 1, further comprising:
transmitting the input image of a source domain and the input image of a target domain to a shared domain invariant encoder to acquire a shared latent embedding feature; and
transforming the shared latent embedding feature into the edge feature and a semantic segmentation feature via different task specific branches.

3. The image analysis method of claim 2, further comprising:
transforming the shared latent embedding feature into initial edge prediction by one of the task specific branches and then acquiring initial edge loss based on the initial edge prediction;
utilizing the edge feature to generate final edge loss relevant to the input image; and
generating edge loss via the initial edge loss and the final edge loss to feedback to the foresaid task specific branch.

4. The image analysis method of claim 3, further comprising:
encrypting the shared latent embedding feature via an encoder of the foresaid task specific branch for generating the edge feature; and
decoding the edge feature into the initial edge prediction via a decoder of the foresaid task specific branch in accordance with an original domain of the input image.

5. The image analysis method of claim 2, further comprising:
transforming the shared latent embedding feature into initial semantic segmentation prediction by one of the task specific branches and then acquiring initial semantic segmentation loss based on the initial semantic segmentation prediction; and
generating semantic segmentation loss via the initial semantic segmentation loss and the final semantic segmentation loss to feedback to the foresaid task specific branch.

6. The image analysis method of claim 5, further comprising:
encrypting the shared latent embedding feature via an encoder of the foresaid task specific branch for generating the semantic segmentation feature; and
decoding the semantic segmentation feature into the initial semantic segmentation prediction via a decoder of the foresaid task specific branch in accordance with an original domain of the input image.

7. The image analysis method of claim 3, further comprising:
utilizing a correlation module and at least one decoder to transform the edge feature and the semantic segmentation feature respectively to the final edge loss and the final semantic segmentation loss.

8. The image analysis method of claim 7, further comprising:
utilizing a convolution function to compute task specific intermediate embedding features of the edge feature and the semantic segmentation feature, for acquiring a modular edge feature corresponding to a final edge output prediction and a modular semantic segmentation feature corresponding to a final semantic segmentation output prediction.

9. The image analysis method of claim 8, further comprising:
utilizing a sigmoid function and the task specific intermediate embedding features to re-weight the edge feature and the semantic segmentation feature, for acquiring the modular edge feature and the modular semantic segmentation feature.

10. The image analysis method of claim 8, further comprising:
transforming the modular edge feature into the final edge output prediction for generating the final semantic segmentation loss by an edge decoder; and
transforming the modular semantic segmentation feature into the final semantic segmentation output prediction for generating the final edge loss by a semantic segmentation decoder.

11. An image analysis system, comprising:
an operation processor adapted to acquire at least one input image, analyze the input image to generate an edge feature of the input image, and utilize the edge feature to generate a final semantic segmentation loss relevant to the input image.

12. The image analysis system of claim 11, wherein the operation processor is adapted to further transmit the input image of a source domain and the input image of a target domain to a shared domain invariant encoder to acquire a shared latent embedding feature, and transform the shared latent embedding feature into the edge feature and a semantic segmentation feature via different task specific branches.

13. The image analysis system of claim 12, wherein the operation processor is adapted to further transform the shared latent embedding feature into initial edge prediction by one of the task specific branches and then acquiring initial edge loss based on the initial edge prediction, utilize the edge feature to generate final edge loss relevant to the input image, and generate edge loss via the initial edge loss and the final edge loss to feedback to the foresaid task specific branch.

14. The image analysis system of claim 13, wherein the operation processor is adapted to further encrypt the shared latent embedding feature via an encoder of the foresaid task specific branch for generating the edge feature, and decode the edge feature into the initial edge prediction via a decoder of the foresaid task specific branch in accordance with an original domain of the input image.

15. The image analysis system of claim 12, wherein the operation processor is adapted to further transform the shared latent embedding feature into initial semantic segmentation prediction by one of the task specific branches and then acquiring initial semantic segmentation loss based on the initial semantic segmentation prediction, and generate semantic segmentation loss via the initial semantic segmentation loss and the final semantic segmentation loss to feedback to the foresaid task specific branch.

16. The image analysis system of claim 15, wherein the operation processor is adapted to further encrypt the shared latent embedding feature via an encoder of the foresaid task specific branch for generating the semantic segmentation feature, and decode the semantic segmentation feature into the initial semantic segmentation prediction via a decoder of the foresaid task specific branch in accordance with an original domain of the input image.

17. The image analysis system of claim 13, wherein the operation processor is adapted to further utilize a correlation module and at least one decoder to transform the edge feature and the semantic segmentation feature respectively to the final edge loss and the final semantic segmentation loss.

18. The image analysis system of claim 17, wherein the operation processor is adapted to further utilize a convolution function to compute task specific intermediate embedding features of the edge feature and the semantic segmentation feature, for acquiring a modular edge feature corresponding to a final edge output prediction and a modular semantic segmentation feature corresponding to a final semantic segmentation output prediction.

19. The image analysis system of claim 18, wherein the operation processor is adapted to further utilize a sigmoid function and the task specific intermediate embedding features to re-weight the edge feature and the semantic segmentation feature, for acquiring the modular edge feature and the modular semantic segmentation feature.

20. The image analysis system of claim 18, wherein the operation processor is adapted to further transform the modular edge feature into the final edge output prediction for generating the final semantic segmentation loss by an edge decoder, and transform the modular semantic segmentation feature into the final semantic segmentation output prediction for generating the final edge loss by a semantic segmentation decoder.
